(19) United States
(12) Patent Application Publication
(10) Pub. No.: US 2003/0234726 A1
(43) Pub. Date: Dec. 25, 2003

(54) Temperature indicating earring assembly

(76) Inventors: Mei-Yen Chen, Tainan City (TW); Jang Fong Lin, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/175,422

(22) Filed: Jun. 20, 2002

(51) Int. Cl. G08B 23/00

(52) U.S. Cl. 340/573.1; 340/584; 340/539.12

(57) ABSTRACT

A temperature indicating earring assembly comprises a main earring member, a first optional earring member, and a second optional earring member. The main earring member is selectively engaged with one of the first optional earring member and the second optional earring member, providing an aesthetic decoration as well as the relax-reminding function.

### BACKGROUND OF THE INVENTION

1. Field of the Invention

The present invention relates to a temperature indicating earring assembly.

2. Description of the Related Art

U.S. Pat. No. 5,813,766 to Chin issued on Sep. 29, 1998 discloses a finger temperature indicating ring for wearing around a finger to measure and indicate the finger surface temperature of the wearer. The ring was designed to replace large biofeedback machines for monitoring finger temperature so that a patient or general user can realize if he or she was really relaxed or not, with the help of the ring. In short, when the body surface temperature is increased, which means vasodilatation and more parasympathetic tone, one is more relaxed. In addition to fingers, the auricle of the ear is also an ideal structure to monitor body surface temperature because its anatomy is even simpler and there is less interference from other histological tissues.

### SUMMARY OF THE INVENTION

It is, therefore, the primary object of the present invention to provide a temperature indicating earring assembly that can be worn on an ear of a patient or general user to monitor the surface temperature over ear auricle to remind the wearer to relax. The temperature indicating earring assembly includes a main earring member, a first optional earring member, and a second optional earring member. The main earring member is selectively engaged with one of the first optional earring member and the second optional earring member, providing an aesthetic decoration as well as the relax-reminding function.

Other objects, advantages, and novel features of the invention will become more apparent from the following detailed description when taken in conjunction with the accompanying drawings.

### BRIEF DESCRIPTION OF THE DRAWINGS

FIG. 1 is an exploded perspective view of a temperature indicating earring assembly in accordance with the present invention.

FIG. 2 is a sectional view illustrating a combination type of the temperature indicating earring assembly in accordance with the present invention.

FIG. 3 is a schematic view illustrating another combination type of the temperature indicating earring assembly in accordance with the present invention.

### DESCRIPTION OF THE PREFERRED EMBODIMENT

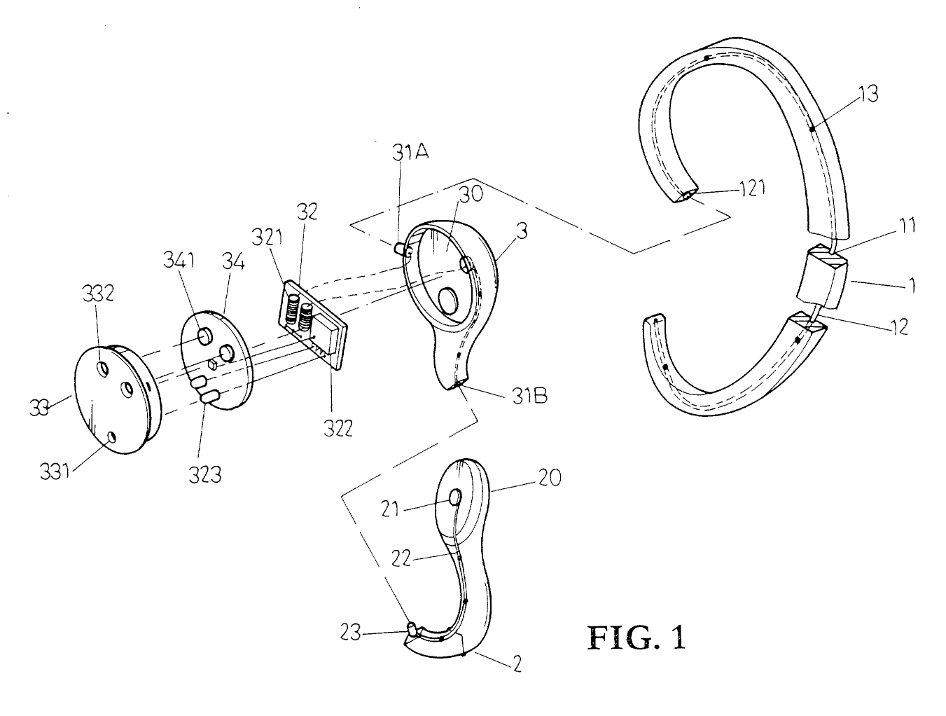

Referring to FIG. 1, a temperature indicating ring assembly in accordance with the present invention generally includes a main earring member 3, a first optional earring member 1, and a second optional earring member 2.

The main earring member 3 includes a compartment 30 for receiving a circuit board 32. A first contact 31A and a second contact 31B are mounted to the main earring member 3. Two receiver elements 321 are mounted on the circuited board 32. One of the receiver elements 321 includes a first end connected to the first contact 31A and a second end connected to an integrated circuit 322 on the circuit board 32. The other receiver element 321 includes a first end connected to the second contact 31B and a second end connected to the integrated circuit 322. Of course, the receiver elements 321 can be incorporated into the integrated circuit 322, and the contacts 31A and 31B can be directly connected to the integrated circuit 322.

A plate 34 may be mounted in the compartment 30 of the main earring member 3 and includes at least one selection button 341. At least one feedback element 323 is mounted to the plate 34, which will be described later. A cover 33 is mounted to enclose the compartment 30 for covering the plate 34 and the circuit board 32. At least one through-hole 331 is defied in the cover 33, allowing the feedback element 323 to extend therethrough to a position beyond the cover 35. The feedback element 323 can be a buzzer or emitter.

The first optional earring member 1 is substantially C-shaped so as to be attached to a back of an ear of a wearer. A groove 11 is defined in a side of the first optional earring member 1 and extends along a length of the first optional earring member 1. A conductive wire 12 is received in the groove 11 and includes a contact 121 exposed outside the first optional earring member 1, and at least one temperature detecting element 13 (e.g., a thermistor) is attached to the conductive wire 12.

The second optional earring member 2 includes an arcuate body 20 (preferably J-shaped) and at least one temperature detecting element 21 mounted on an end thereof. A contact 23 is provided on the other end of the arcuate body 20 and connected to the temperature detecting element 21 by a conductive wire 22.

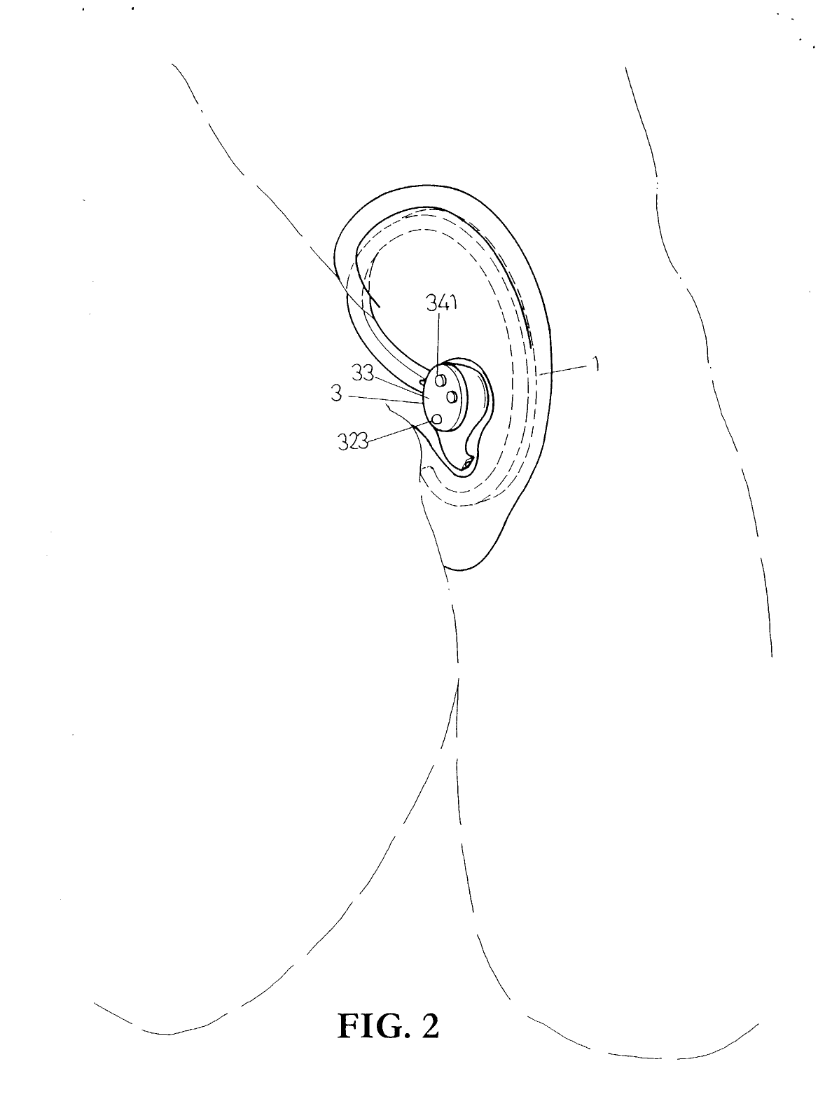

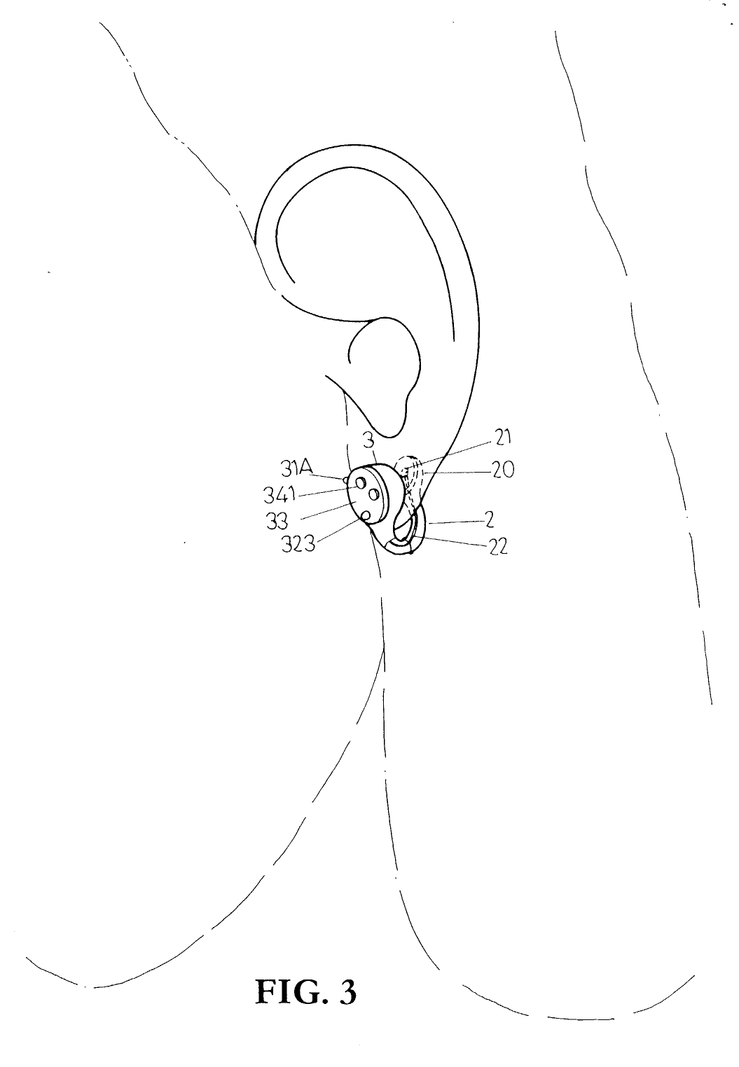

In use, the main earring member 3 may be used together with either the first optional earring member 1 (FIG. 2) or the second optional earring member 2 (FIG. 3).

When the main earring member 3 is used with the first optional earring member 1, as illustrated in FIG. 2, the C-shaped first optional earring member 1 extends along a back of an ear of a wearer. An upper end of the C-shaped first optional earring member 1 extends to a front of the ear, and a lower end of the C-shaped first optional earring member 1 hooks around a lower portion of a lobe of the ear of the wearer. The main earring member 3 is located to a front side of the lobe of the ear of the wearer with the first contact 31A of the first optional earring member 2 being connected to the contact 121 on the upper end of the C-shaped first optional earring member 1. The heat detecting element 13 is in contact with the skin of the back of the ear of the wearer. Thus, the temperature of the ear is detected by the heat-detecting element 13 and conducted to the conductive wire 12. It is noted that resistance of the conductive wire 12 varies in response to its temperature. Thus, the resistance value according to the temperature of the ear of the wearer is transmitted to the integrated circuit 322 through the contact 121, the first contact 31A, and an associated one of the receiver element 321. The integrated circuit 322 performs an operation based on the resistance value from the conductive wire 12. The feedback element 323 is activated to inform the user when the detected resistance value is determined to be outside a pre-determined normal range stored in the integrated circuit 322 after the operation.

When the main earring member 3 is used with the second optional earring member 2, as illustrated in FIG. 3, the contact 23 of the J-shaped second optional earring member 2 and is connected to the second contact 31B of the main earring member 3. In this embodiment, the contact 23 of the J-shaped optional earring member 2 is a male contact and the second contact 31B is a female contact. The main earring member 3 is attached to the front side of the lobe of the ear of the wearer. And the temperature detecting element 21 of the second optional earring member 2 is attached to a rear side of the lobe of the ear of the wearer. Thus, the main earring member 3 and the second optional earring member 2 look like an earring, and a female wearer may prefer this option. The main earring member 3 and the second optional earring member 2 are so configured that a clamping force is exerted on the lobe of the ear of the wearer when the main earring member 3 and the second optional earring member 2 are attached to the lobe of the ear of the wearer, thereby preventing falling of the main earring member 3 and the second optional earring member 2. The heat detecting element 21 is in contact with the skin of the lobe of the ear of the wearer. Thus, the temperature of the ear is detected by the heat-detecting element 21 and conducted to the conductive wire 22. It is noted that resistance of the conductive wire 22 varies in response to its temperature. Thus, the resistance value according to the temperature of the ear of the wearer is transmitted to the integrated circuit 322 through the contact 23, the second contact 31B, and an associated one of the receiver element 321. The integrated circuit 322 performs an operation based on the resistance value from the conductive wire 22. The feedback element 323 is activated to inform the user when the detected resistance value is determined to be outside a pre-determined normal range stored in the integrated circuit 322 after the operation.

The user will be reminded by several options including low-volume buzzing by a buzzer and/or slight vibration by a vibration motor. Thus, the user may perceive the buzzing and/or vibration and take necessary steps to relax to avoid any discomfort caused by physical and mental tension. Of course, a signal may be emitted by an infrared or radio emitter so as to be received by a receiver, e.g., a receiver owned by a doctor who is in charge of a patient who suffers from psychiatric illness and thus wears the temperature indicating earring. Thus, the doctor may take necessary steps whenever the patient is in an emergent condition. Of course, the integrated circuit 322 may include a so-called “bluetooth” module incorporated therein, and the receiver can be a mobile phone, a personal digital assistant, or a receiver device connected to or incorporated in a computer. A battery (not shown) may be mounted to the circuit board 32 for supply power to the integrated circuit 322 and the feedback element 323. The selection buttons 341 are provided to select the options of reminding as well as emitting of the information of the detected temperature. The cover 33 includes two through-holes 332 through which the selection buttons 341 extend.

According to the above description, it is appreciated that the temperature indicating earring assembly in accordance with the present invention may remind the user to relax and provide decoration. Low-volume buzzing of the buzzer adjacent to the ear may avoid embarrassment and interference to people adjacent to the user. Of more importance, adverse affect to the detection resulting from the ambient temperature can be minimized.

Although the invention has been explained in relation to its preferred embodiment, it is to be understood that many other possible modifications and variations can be made without departing from the scope of the invention as hereinafter claimed.

What is claimed is:

1. A temperature indicating earring assembly comprising:
a main earring member adapted to be attached to a front side of an ear of a wearer, the main earring member including a first contact and a second contact provided thereon, the main earring member including a compartment, a circuit board being mounted in the compartment, an integrated circuit being mounted on the circuit board and connected to the first contact and the second contact;
a first optional earring member adapted to be attached to a back of the ear of the wearer, the first optional earring member being substantially C-shaped and including an upper end that extends to a front of the ear of the wear when the first optional earring member is attached to the back of the ear of the wearer, the first optional earring member further including a lower end that hooks around a lower portion of a lobe of the ear of the wearer when the first optional earring member is attached to the back of the ear of the wearer, the first optional earring member including a groove defined in a side thereof, a first conductive wire being mounted in the groove and including a third contact, at least one first temperature detecting element being attached to the first conductive wire, said at least one first temperature detecting element being in contact with a skin of the ear of the wearer for detecting temperature of the ear of the wearer when the first optional earring member is attached to the back of the ear of the wearer; and
a second optional earring member adapted to be attached to a lower portion of the ear of the wearer and including an arcuate body, the second optional earring member including at least one second temperature detecting element that is in contact with the skin of the ear of the wearer for detecting temperature of the ear of the wearer when the second optional earring member is attached to the lower portion of the ear of the wearer, the second optional earring member further including a fourth contact that is connected to said at least one second temperature detecting element by a second conductive wire;
the main earring member being selectively engaged with one of the first optional earring member and the second optional earring member;
wherein when the main earring member is engaged with the first optional earring member, the first contact of the main earring member is connected to the third contact of the first optional earring member, the integrated circuit receiving input of a resistance value of the first conductive wire as a result of detected temperature of the ear of the wearer; wherein when the main earring member is engaged with the second optional earring member, the second contact of the main earring member is connected to the fourth contact of the second optional earring member, the integrated circuit receiving input of a resistance value of the second conductive wire as a result of detected temperature of the ear of the wear; and a feedback element connected to the integrated circuit for monitoring ear temperature so that the wearer can realize if he or she is relaxed or not.

2. The temperature indicating earring assembly as claimed in claim 1, wherein the feedback element is a buzzer.

3. The temperature indicating earring assembly as claimed in claim 1, wherein the feedback element is a vibration motor.

4. The temperature indicating earring assembly as claimed in claim 1, wherein the feedback element is an emitter for emitting information of the detected temperature to a distant receiver.

5. The temperature indicating earring assembly as claimed in claim 1, further comprising a cover for covering the compartment of the main earring member.

6. The temperature indicating earring assembly as claimed in claim 5, wherein the cover includes a through-hole through which the feedback element extends.

7. The temperature indicating earring assembly as claimed in claim 2, further comprising a vibration motor.

8. The temperature indicating earring assembly as claimed in claim 7, further comprising an emitter for emitting information of the detected temperature to a distant receiver.

9. The temperature indicating earring assembly as claimed in claim 8, further comprising at least one selection button for switching operation between the buzzer, the vibration motor, and the emitter.

10. The temperature indicating earring assembly as claimed in claim 1, wherein the second contact of the main earring member is a female contact and the fourth contact of the second optional earring member is a male contact.

11. The temperature indicating earring assembly as claimed in claim 10, wherein the main earring member and the second optional earring member together exert a clamping force to a lobe of the ear of the wear.

12. The temperature indicating earring assembly as claimed in claim 1, wherein the main earring member is attached to a lobe of the ear of the wearer.

13. A temperature indicating earring assembly comprising:
a first earring member adapted to be attached to a front side of an ear of a wearer, the main earring member including a first contact provided thereon, the main earring member including a compartment, a circuit board being mounted in the compartment, an integrated circuit being mounted on the circuit board and connected to the first contact; and
a second earring member adapted to be attached to a back of the ear of the wearer, the second earring member including a second contact connected to the first contact of the first earring member, at least one temperature detecting element being mounted on the second earring member and connected to the second contact by a conductive wire;
the integrated circuit receiving input of a resistance value of the first conductive wire as a result of detected temperature of the ear of the wear; and
a feedback element connected to the integrated circuit for reminding the user when the resistance value is not within a pre-determined normal range.

14. The temperature indicating earring assembly as claimed in claim 13, wherein the feedback element is a buzzer.

15. The temperature indicating earring assembly as claimed in claim 13, wherein the feedback element is a vibration motor.

16. The temperature indicating earring assembly as claimed in claim 13, wherein the feedback element is an emitter for emitting information of the detected temperature to a distant receiver.

17. The temperature indicating earring assembly as claimed in claim 13, further comprising a cover for covering the compartment of the main earring member.

18. The temperature indicating earring assembly as claimed in claim 17, wherein the cover includes a through-hole through which the feedback element extends.

19. The temperature indicating earring assembly as claimed in claim 13, wherein the first earring member and the second earring member together exert a clamping force to a lobe of the ear of the wear.

20. The temperature indicating earring assembly as claimed in claim 14, further comprising an emitter for emitting information of the detected temperature to a distant receiver.
